(19) United States
(12) Patent Application Publication
(10) Pub. No.: US 2026/0367468 A1
(43) Pub. Date: Nov. 19, 2026

(54) ARRAY SUBSTRATE, METHOD FOR MANUFACTURING THEREOF AND FLEXIBLE ELECTRONIC PAPER DISPLAY PANEL

(71) Applicant: HKC CORPORATION LIMITED, Shenzhen (CN)

(72) Inventors: JUNHONG CAO, Shenzhen (CN); Lidan YE, Shenzhen (CN)

(21) Appl. No.: 19/662,769

(22) Filed: Apr. 29, 2026

(30) Foreign Application Priority Data
May 16, 2025 (CN) 202510633746.4

(51) Int. Cl. G02F 1/1685; G02F 1/167

(52) U.S. Cl. CPC G02F 1/1685; G02F 1/167

(57) ABSTRACT

Disclosed are an array substrate, a method for manufacturing thereof and a flexible electronic paper display panel. The array substrate includes a plurality of pixel unit regions, each of the plurality of pixel unit regions being divided into a thickened region and a regular region. The array substrate further includes a substrate, a first metal electrode, a first insulating protective layer and a second electrode. An orthographic projection of the first metal electrode on the substrate overlaps that of the second electrode on the substrate within each of the plurality of pixel unit regions. A boundary of the first metal electrode is disposed within the thickened region, and a thickness of the first insulating protective layer in the thickened region is greater than a thickness of the first insulating protective layer in the regular region.

### CROSS-REFERENCE TO RELATED APPLICATIONS

The present disclosure claims the priority and benefit of Chinese patent application number 2025106337464, titled "Array Substrate, Method For Manufacturing Thereof And Flexible Electronic Paper Display Panel" and filed on May 16, 2025 with China National Intellectual Property Administration, the entire contents of which are incorporated herein by reference.

### TECHNICAL FIELD

The present disclosure relates to the technical field of display, and more particularly relates to an array substrate, a method for manufacturing thereof and a flexible electronic paper display panel.

### BACKGROUND

The description provided in this section is intended for the mere purpose of providing background information related to the present disclosure but does not necessarily constitute prior art.

With the development of digital technology, more and more display devices are entering people's lives, such as electronic paper (hereinafter referred to as EP) display panels. Flexible EP display panels are increasingly favored because they may maintain their display for extended periods even when power is off, and they offer advantages such as being lightweight, thin, having low power consumption, and simple manufacturing processes.

Currently, flexible EP display panels, using flexible substrates made of polyimide film, may be rolled up and folded arbitrarily. However, repeated bending during use may lead to a decrease in grayscale in some areas.

### SUMMARY

An objective of the present disclosure is to provide an array substrate, a method for manufacturing thereof and a flexible electronic paper display panel, which avoids the problem of grayscale degradation in some areas of the flexible electronic paper display panel.

The present disclosure discloses an array substrate, applied to a flexible electronic paper display panel, including a plurality of pixel unit regions, each of the plurality of pixel unit regions being divided into a thickened region and a regular region. The array substrate further includes a substrate, a first metal electrode, a first insulating protective layer and a second electrode. The first metal electrode, the first insulating protective layer and the second electrode are sequentially disposed on the substrate. An orthographic projection of the first metal electrode on the substrate overlaps that of the second electrode on the substrate within each of the plurality of pixel unit regions. A boundary of the first metal electrode is disposed within the thickened region, and a thickness of the first insulating protective layer in the thickened region is greater than a thickness of the first insulating protective layer in the regular region.

The present disclosure discloses a method for manufacturing an array substrate. The array substrate includes a plurality of pixel unit regions, each of the plurality of pixel unit regions being divided into a thickened region and a regular region. The method for manufacturing an array substrate includes:
forming a first metal electrode on a substrate;
forming a first insulating protective layer on the first metal electrode, wherein a boundary of the first metal electrode is disposed within the thickened region; a thickness of the first insulating protective layer in the thickened region is greater than a thickness of the first insulating protective layer in the regular region;
forming a second electrode on the first insulating protective layer.

The present disclosure further discloses a flexible electronic paper display panel, including an electrophoretic reflective layer and an array substrate, the array substrate being configured to drive the electrophoretic reflective layer to reflect light for displaying an image. The array substrate includes a plurality of pixel unit regions, each of the plurality of pixel unit regions being divided into a thickened region and a regular region. The array substrate further includes a substrate, a first metal electrode, a first insulating protective layer and a second electrode. The first metal electrode, the first insulating protective layer and the second electrode are sequentially disposed on the substrate. The first metal electrode overlaps the second electrode in the orthographic projection on the substrate within each of the plurality of pixel unit regions. A boundary of the first metal electrode is disposed within the thickened region, and a thickness of the first insulating protective layer in the thickened region is greater than a thickness of the first insulating protective layer in the regular region.

Compared to the array substrate of exemplary technologies, the present disclosure provides the first insulating protective layer, with the thickness of the first insulating protective layer in the thickened region being greater than the thickness of the first insulating protective layer in the regular region. Specifically, the first insulating protective layer is thickened at a position covering a boundary of the first metal electrode. This prevents the edges of the first metal electrode from bending and scratching the first insulating protective layer when the flexible electronic paper display panel is repeatedly bent, and also prevents the storage capacitance in the plurality of pixel unit regions from decreasing, thus solving the problem of grayscale degradation in certain areas of the flexible electronic paper display panel.

### BRIEF DESCRIPTION OF DRAWINGS

The included drawings are provided for further understanding of embodiments of the present disclosure, constitute a part of the specification, illustrate embodiments of the present disclosure, and together with the text description, explain principles of the present disclosure. Obviously, the drawings in the following description are merely some embodiments of the present disclosure. For those of ordinary skill in the art, other drawings may be obtained based on these drawings without creative labor. In the drawings:

FIG. 1 is a schematic diagram of a flexible electronic paper display panel according to an embodiment of the present disclosure.

FIG. 2 is a plan view of a pixel unit region according to a first embodiment of the present disclosure.

FIG. 3 is a schematic diagram of a first array substrate according to a first embodiment of the present disclosure.

FIG. 4 is a schematic diagram of a second array substrate according to a first embodiment of the present disclosure.

FIG. 5 is a plan view of an active switch according to a first embodiment of the present disclosure.

FIG. 6 is a cross-sectional view of a semiconductor layer according to a first embodiment of the present disclosure.

FIG. 7 is a schematic diagram of a dual-gate active switch according to a first embodiment of the present disclosure.

FIG. 8 is a schematic diagram of an array substrate according to a second embodiment of the present disclosure.

FIG. 9 is a schematic diagram of an array substrate according to a third embodiment of the present disclosure.

FIG. 10 is a schematic diagram of an array substrate according to a fourth embodiment of the present disclosure.

FIG. 11 is a flowchart of steps of a method for manufacturing an array substrate according to an embodiment of the present disclosure.

FIG. 12 is a schematic diagram illustrating a method for manufacturing an array substrate according to an embodiment of the present disclosure.

Reference Numerals: 10, a flexible electronic paper display panel; 20, electrophoretic reflective layer; 21, microcapsule; 22, common electrode layer; 30, array substrate; 40, pixel unit region; 41, thickened region; 42, regular region; 43, switching region; 44, overlapping region; 45, non-overlapping region; 100, substrate; 110, first metal layer; 120, gate insulating layer; 130, second metal layer; 140, passivation insulating layer; 150, pixel electrode layer; 210, first metal electrode; 220, second electrode; 310, first insulating protective layer; 311, first elastic layer; 312, first insulating layer; 320, second insulating protective layer; 321, second elastic layer; 322, second insulating layer; 410, common electrode line; 420, pixel electrode; 430, auxiliary pixel electrode; 510, active switch; 520, gate; 521, first sub-gate; 522, second sub-gate; 530, semiconductor layer; 531, first sub-semiconductor layer; 532, second sub-semiconductor layer; 540, source; 550, connecting electrode; 560, drain; 610, data line; 620, scan line.

### DETAILED DESCRIPTION OF EMBODIMENTS

It should be understood that the terminology, specific structures, and functional details disclosed herein are merely used to describe specific embodiments and are illustrative. However, the present disclosure may be implemented through many alternative forms and should not be construed as limited solely to the embodiments described herein.

In the description of the present disclosure, terms such as "first" and "second" are used solely for descriptive purposes and should not be interpreted as indicating relative importance or implicitly specifying the number of technical features indicated. Thus, unless otherwise specified, features qualified by "first" or "second" may explicitly or implicitly include one or more such features. "A plurality of" means two or more. Additionally, directional or positional terms such as "upper," "lower," "left," "right," "vertical," or "horizontal" are described based on orientations or relative positional relationships shown in the accompanying drawings, which are used for simplified description to facilitate understanding of the present application and do not imply that the devices or elements described should have specific orientations or be constructed or operated in specific orientations. These terms should not be construed as limiting the present disclosure. For those skilled in the art, the specific meaning of the above terms in the context of the present disclosure may be understood according to the specific situation.

The present disclosure is described below in detail with reference to the accompanying drawings and optional embodiments.

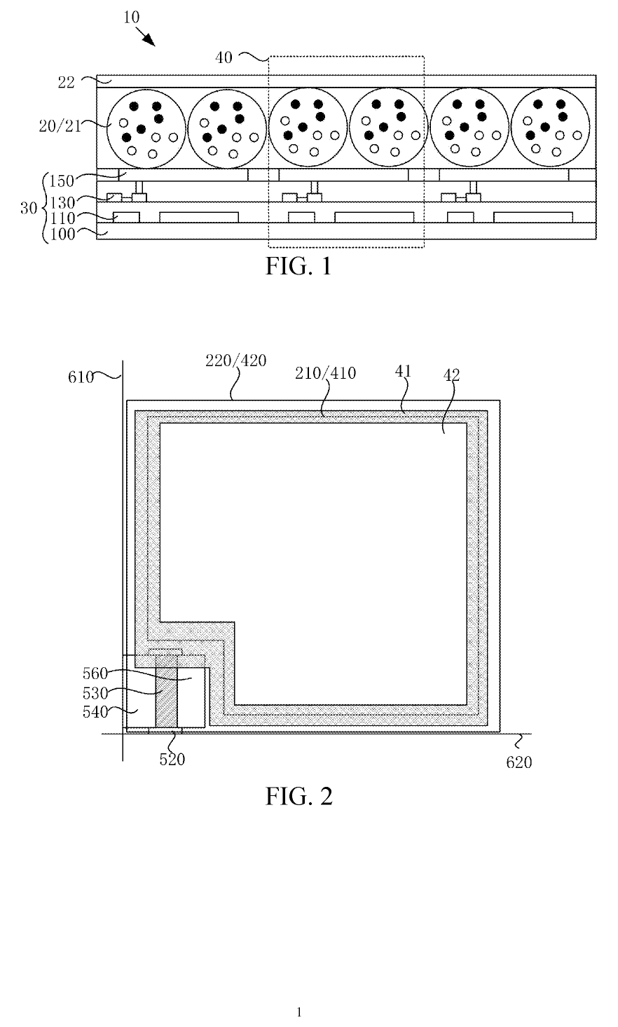

FIG. 1 is a schematic diagram of a flexible electronic paper display panel according to an embodiment of the present disclosure. As shown in FIG. 1, the present disclosure discloses a flexible electronic paper display panel 10, which includes an electrophoretic reflective layer 20 and an array substrate 30. The array substrate 30 is configured to drive the electrophoretic reflective layer 20 to reflect light for displaying an image.

The electrophoretic reflective layer 20 may vary depending on the type of flexible electronic paper display panel 10. For example, it may be a microcapsule type electrophoretic reflective layer 20 or a microcup type electrophoretic reflective layer 20. The electrophoretic reflective layer 20 may use electrophoretic particles and electrophoretic ink to reflect and absorb external light.

In some embodiments, the present disclosure utilizes a microcapsule type electrophoretic reflective layer 20 as an example for explanation and description. Moreover, according to actual needs, the microcapsule 21 may include black particles, white particles, red particles, green particles, and blue particles, etc.

The present disclosure further discloses an array substrate 30 and the array substrate 30 may be applied to a flexible electronic paper display panel described above. Regarding the array substrate 30, the present disclosure provides the following design, which is specifically described through several embodiments.

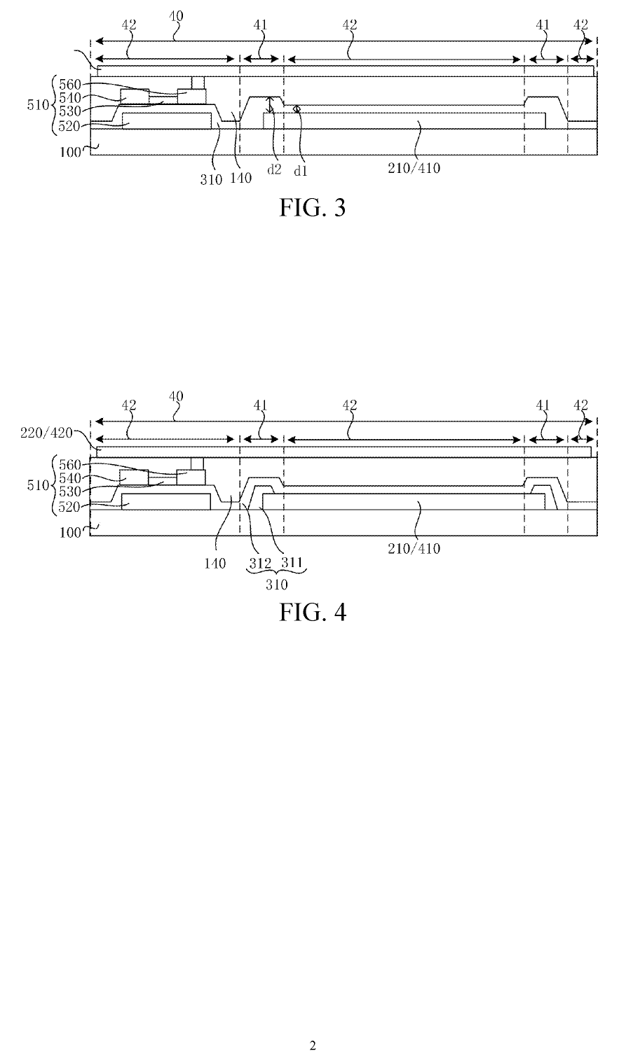

FIG. 2 is a plan view of a pixel unit region according to a first embodiment of the present disclosure. FIG. 3 is a schematic diagram of a first array substrate according to a first embodiment of the present disclosure. As shown in FIGS. 2 and 3, the present disclosure discloses an array substrate 30, configured for a flexible electronic paper display panel 10, including a plurality of pixel unit regions 40, each of the plurality of pixel unit regions 40 being divided into a thickened region 41 and a regular region 42. The array substrate 30 further includes a substrate 100, a first metal electrode 210, a first insulating protective layer 310 and a second electrode 220. The first metal electrode 210, the first insulating protective layer 310 and the second electrode 220 are sequentially disposed on the substrate 100. An orthographic projection of the first metal electrode 210 on the substrate 100 overlaps that of the second electrode 220 on the substrate within each of the plurality of pixel unit regions 40. A boundary of the first metal electrode 210 is disposed within the thickened region 40, and a thickness of the first insulating protective layer 310 in the thickened region 41 is greater than a thickness of the first insulating protective layer 310 in the regular region 42. Specifically, the first insulating protective layer 310 is thickened at the thickened region 41.

The first metal electrode 210 includes metal, such as copper. The second electrode 220 includes metal or a metal oxide.

In some embodiments, a storage capacitor is formed between the first metal electrode 210 and the second electrode 220. Since the charging speed of the pixel electrode 420 of the array substrate 30 is much greater than the movement speed of the particles within the microcapsule 21, the area of the first metal electrode 210 needs to be relatively large within each of the plurality of pixel unit regions 40, resulting in a relatively large storage capacitor formed between the first metal electrode 210 and the second electrode 220. In the exemplary technology, the first metal electrode is linear, however, while in the present disclosure, the first metal electrode 210 is block-shaped.

It may be understood that in the exemplary technology, the array substrate 30 has an insulating layer between the first metal electrode 210 and the second electrode 220. When the flexible electronic paper display panel 10 is repeatedly bent, each film layer will shift to the left and right relative to the substrate 100 around its center line. Since the first metal electrode 210 has a large area and is typically disposed on the first metal layer 110 or a second metal layer 130, the offset of the first metal electrode 210 during bending is significant, resulting in edge warping. This causes scratches on the insulating layer originally disposed between the first metal electrode 210 and the second electrode 220, leading to leakage of the storage capacitance between the first metal electrode 210 and the second electrode 220. Even worse, it may cause breakdown of the first metal electrode 210 and the second electrode 220, preventing the formation of the storage capacitance between them. This results in a decrease in grayscale in the scratched areas when the flexible electronic paper display panel 10 is displayed.

Compared to the array substrate 30 of exemplary technologies, the present disclosure provides the first insulating protective layer 310, with the thickness of the first insulating protective layer 310 in the thickened region 41 being greater than the thickness of the first insulating protective layer 310 in the regular region 42. Specifically, the first insulating protective layer 310 is thickened at a position covering a boundary of the first metal electrode 210. This prevents the edges of the first metal electrode 210 from bending and scratching the first insulating protective layer 310 when the flexible electronic paper display panel 10 is repeatedly bent, and also prevents the storage capacitance in the plurality of pixel unit regions 40 from decreasing, thus solving the problem of grayscale degradation in certain areas of the flexible electronic paper display panel 10. Furthermore, this design also prevents moisture intrusion, avoiding corrosion of the first metal electrode 210 and display abnormalities.

In some embodiments, the first metal electrode 210 is a common electrode line 410, the second electrode 220 is a pixel electrode 420, the array substrate 30 further includes a passivation insulating layer 140, and the common electrode line 410, the first insulating protective layer 310, the passivation insulating layer 140 and the pixel electrode 420 are sequentially disposed on the substrate 100.

The array substrate 30 further includes a plurality of data lines 610, a plurality of scan lines 620, and a plurality of active switches 510. In some embodiments, the plurality of data lines 610, the plurality of scan lines 620, and the plurality of active switches 510 are respectively disposed on the substrate 100. The gate 520 of each of the plurality of active switches 510 is connected to one of the plurality of scan lines 620, the source 540 of each of the plurality of active switches 510 is connected to one of the plurality of data lines 610, and the plurality of pixel electrodes 420 are respectively connected to the drains 560 of the plurality of active switches 510.

It is understood that a first metal layer 110, a first insulating protective layer 310, a second metal layer 130, a passivation insulating layer 140 and a pixel electrode layer 150 are sequentially defined on the substrate 100. In some embodiments, the first metal electrode 210 is in the first metal layer 110 and the second electrode 220 is in the pixel electrode layer 150.

Each of the plurality of active switches 510 includes a top gate type active switch and a bottom gate type active switch. For example, when each of the plurality of active switches 510 is a top gate type active switch, the gate 520 of each of the plurality of active switches 510 and the first metal electrode 210 (i.e., the common electrode 410) are located within the first metal layer 110. The source 540 and the drain 560 of each of the plurality of active switches 510 are located within the second metal layer 130. The semiconductor layer 530 of each of the plurality of active switches 510 is located between the first insulating protective layer 310 and the second metal layer 130.

In some embodiments, the thickened region 41 covers a boundary of the first metal electrode 210. The thickened region 41 extends 8 μm to 10 μm inwardly from the boundary of the first metal electrode 210; and the thickened region 40 extends 8 μm to 10 μm outwardly from the boundary of the first metal electrode 210.

In some embodiments, the thickened region 40 completely covers the boundary of the first metal electrode 210 entirely; or the thickened region 40 only covers a portion of the boundary of the first metal electrode 210.

The thickness of the first insulating protective layer 310 in the regular region 42 is defined as d1. The thickness of the first insulating protective layer 310 in the thickened region 41 is defined as d2. d2 is greater than d1. Furthermore, to avoid unevenness on the surface of the second metal layer 130 above the first insulating protective layer 310 after thickening the first insulating protective layer 310 in the thickened region 41, d2 = d1 + d3 in the present disclosure. Here, d3 is the thickness of the second metal layer 130, that is, the thickness of the source 540 of each of the plurality of active switches 510 and the thickness of the drain 560 of each of the plurality of active switches 510 are both d3.

As shown in FIG. 3, the present disclosure may render the thickness of the first insulating protective layer 310 in the thickened region 41 greater than the thickness of the first insulating protective layer 310 in the regular region 42 by means of a manufacturing process. Specifically, during the fabrication of the first insulating protective layer 310, a halftone process may be utilized to irradiate both the thickened region 41 and the regular region 42. The tonal range of the thickened region 41 is 0%-10%, and the tonal range of the regular region 42 is 40%-60%. This results in a first insulating protective layer 310 with a greater thickness in the thickened region 41 than in the regular region 42.

FIG. 4 is a schematic diagram of a second array substrate according to a first embodiment of the present disclosure. As shown in FIG. 4, the present disclosure may also increase the thickness of the first insulating protective layer 310 in the thickened region 41 to be greater than the thickness of the regular region 42 by adding a first elastic layer 311.

Specifically, the first insulating protective layer 310 includes the first elastic layer 311 and a first insulating layer 312. The first elastic layer 311 is located between the first metal electrode 210 and the first insulating layer 312, and the first elastic layer 311 is only located in the thickened region 41, so that the thickness of the first insulating protective layer 310 in the thickened region 41 is greater than the thickness of the first insulating protective layer 310 in the regular region 42.

In other words, the first elastic layer 311 covers the boundary of the first metal electrode 210 layer. In some embodiments, the first elastic layer 311 covers the boundary of the common electrode line 410. It is understood that the thickness of the first insulating protective layer 310 is uniform, a thickness of the first elastic layer 311 is in a range of 8000 μm to 10000 μm, and the thickness of the first insulating layer 312 is in a range of 3500 μm to 4000 μm.

The first elastic layer 311 is made of polystyrene (hereinafter referred to as PS) spacer material. The PS spacer material is elastic. Therefore, when the flexible electronic paper display panel 10 is bent, the first metal electrode 210 shifts, squeezing the PS spacer material at the edge. The PS spacer material deforms under pressure. Then, when the flexible electronic paper display panel 10 returns to flatness, the PS spacer material recovers its deformation and acts back on the first metal electrode 210. On the one hand, this prevents the first metal electrode 210 from shifting and failing to return to its original position under repeated bending of the flexible electronic paper display panel 10, which would reduce the overlap area between the first metal electrode 210 and the second electrode 220, resulting in relatively less capacity of the storage capacitance in the plurality of pixel unit regions 40. On the other hand, because the PS spacer material is elastic, it may absorb the shift of the first metal electrode 210, thereby preventing damage to the first insulating protective layer 310.

In some embodiments, each of the plurality of active switches 510 is a bottom gate type active switch 510, with the gate 520 of each of the plurality of active switches 510 on the first metal layer 110 and the source 540 and drain 560 of each of the plurality of active switches 510 on the second metal layer 130. Specifically, in the flexible electronic paper display panel 10, the area of the first metal electrode 210 is relatively large. Therefore, the first insulating protective layer 310 is thickened at the edge corresponding to the first metal electrode 210. This causes a portion of the semiconductor layer 530, source 540, and drain 560 of each of the plurality of active switches 510 to be raised. Consequently, the distance between the gate 520 and the semiconductor layer 530 at the raised position is greater than the distance between the gate 520 and the semiconductor layer 530 at the non-raised position, resulting in a reduction in the charging capability of each of the plurality of active switches 510.

Therefore, the present disclosure also improves the plurality of active switches 510, as detailed below.

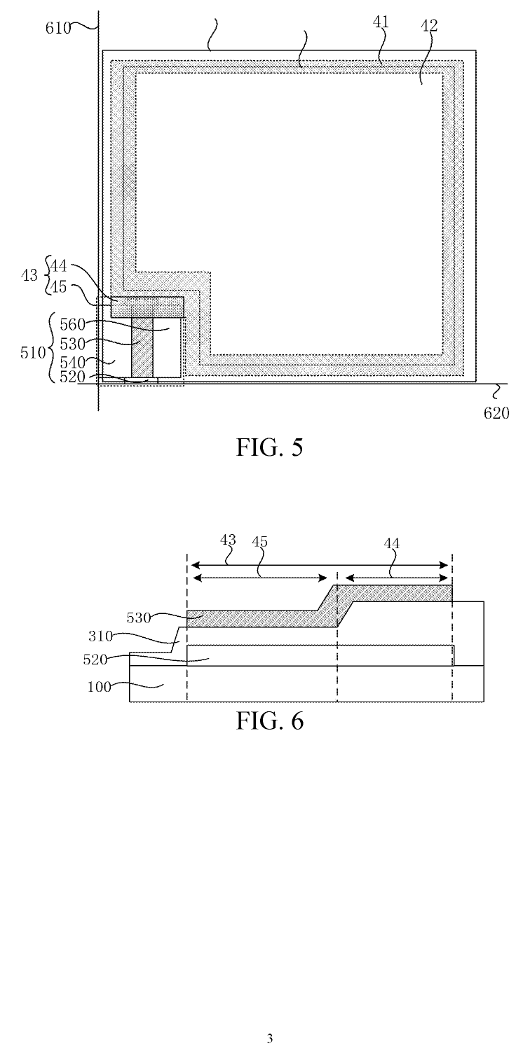

FIG. 5 is a plan view of an active switch according to a first embodiment of the present disclosure. FIG. 6 is a cross-sectional view of a semiconductor layer according to a first embodiment of the present disclosure. As shown in FIGS. 5 and 6, the array substrate 30 further includes a plurality of active switches 510, each of the plurality of active switches includes a gate 520, a semiconductor layer 530, a source 540, and a drain 560. The gate 520 is disposed in the same layer as the first metal electrode 210, and the source 540 and the drain 560 are disposed in the same layer as the second electrode 220. The semiconductor layer 530 is located between the first insulating protective layer 310, the source 540 and the drain 560.

The region where the active switch 510 is located within each of the plurality of pixel unit regions is defined as a plurality of switching regions 43. Each of the plurality of switching regions 43 includes an overlapping region 44 and a non-overlapping region 45, and a region where the switching region 43 partially overlaps with the thickened region 41 is defined as the overlapping region 44. A distance between the semiconductor layer 530 and the gate 520 in the overlapping region 44 is greater than a distance between the semiconductor layer 530 and the gate 520 in the non-overlapping region 45.

An on-state current of the plurality of active switches 510 in the overlapping region 44 is the same as an on-state current of the plurality of active switches 510 in the non-overlapping region 45.

The on-state current refers to the conduction current between the source 540 and the drain 560 when the same gate voltage is applied to the gate 520. In short, the thickened region 41 of the first insulating protective layer 310 extends to the overlapping region 44 of the plurality of active switches 510, causing the semiconductor layer 530 in the overlapping region 44 of the plurality of active switches 510 to be raised. Consequently, that is, the distance between the semiconductor layer 530 in the overlapping region 44 and the gate 520 is greater than the distance between the semiconductor layer 530 and the gate 520 in the non-overlapping region 45.

In the plurality of active switches 510, as the distance between the gate 520 and the semiconductor layer 530 increases, the required turn-on voltage for the plurality of active switches 510 also increases. Therefore, the present disclosure limits the on-state current of the plurality of active switches 510 in the overlapping region 44 to be the same as the on-state current of the plurality of active switches 510 in the non-overlapping region 45. This avoids both reducing the area of the first metal electrode 210 and decreasing the storage capacitance within each of the plurality of pixel unit regions 40; and it also avoids increasing the voltage of the plurality of scan lines 620 and reducing the load on the flexible electronic paper display panel 10.

In some embodiments, a channel length of the plurality of active switches 510 in the overlapping region 44 of the semiconductor layer 530 is less than a channel length of the plurality of active switches 510 in the non-overlapping region 45 of the semiconductor layer 530. For instance, the channel length of the plurality of active switches 510 corresponding to the semiconductor layer 530 in the overlapping region 44 is 4.5 μm, and the channel length of the plurality of active switches 510 corresponding to the semiconductor layer 530 in the non-overlapping region 45 is 6 μm. This compensates for the problem of reduced charging capability of the plurality of active switches 510 caused by the thickened region 41 of the first insulating protective layer 310 in the overlapping region 44, thereby making the on-state current of the plurality of active switches 510 in the overlapping region 44 the same as the on-state current of the plurality of active switches 510 in the non-overlapping region 45, without requiring additional processing steps.

In some embodiments, the molar ratio of Ca²⁺ doping in the semiconductor layer 530 of the plurality of active switches 510 in the overlapping region 44 is greater than the molar ratio of Ca²⁺ doping in the semiconductor layer 530 of the plurality of active switches 510 in the non-overlapping region 45. By doping the semiconductor layer 530 of the plurality of active switches 510 in the overlapping region 44 with Ca²⁺, the driving capability of the plurality of active switches 510 in that region is improved. For example, the plurality of active switches 510 are doped with 3% molar ratio of Ca²⁺ in the semiconductor layer 530 of the overlapping region 44 and with 0.5% molar ratio of Ca²⁺ in the semiconductor layer 530 of the non-overlapping region 45. This makes the driving capability of the plurality of active switches 510 in the overlapping region 44 and the non-overlapping region 45 comparable, and the on-state current of the plurality of active switches 510 in the overlapping region 44 is the same as the on-state current of the plurality of active switches 510 in the non-overlapping region 45.

In some embodiments, the semiconductor layer 530 includes an active layer and an ohmic doped layer. The thickness of the active layer of the plurality of active switches 510 in the overlapping region 44 is greater than the thickness of the active layer of the plurality of active switches 510 in the non-overlapping region 45. For example, defining the original film thickness as 1800 Å to 2100 Å, the driving capability of the active switches 510 is strongest when the original film thickness is 35% to 40% of the original film thickness. The thickness of the active layer of the plurality of active switches 510 in the overlapping region 44 is 630 Å to 840 Å, and the thickness of the active layer of the plurality of active switches 510 in the non-overlapping region 45 is 540 Å to 630 Å. This allows the on-state current of the plurality of active switches 510 in the overlapping region 44 to be the same as the on-state current of the active switches 510 in the non-overlapping region 45.

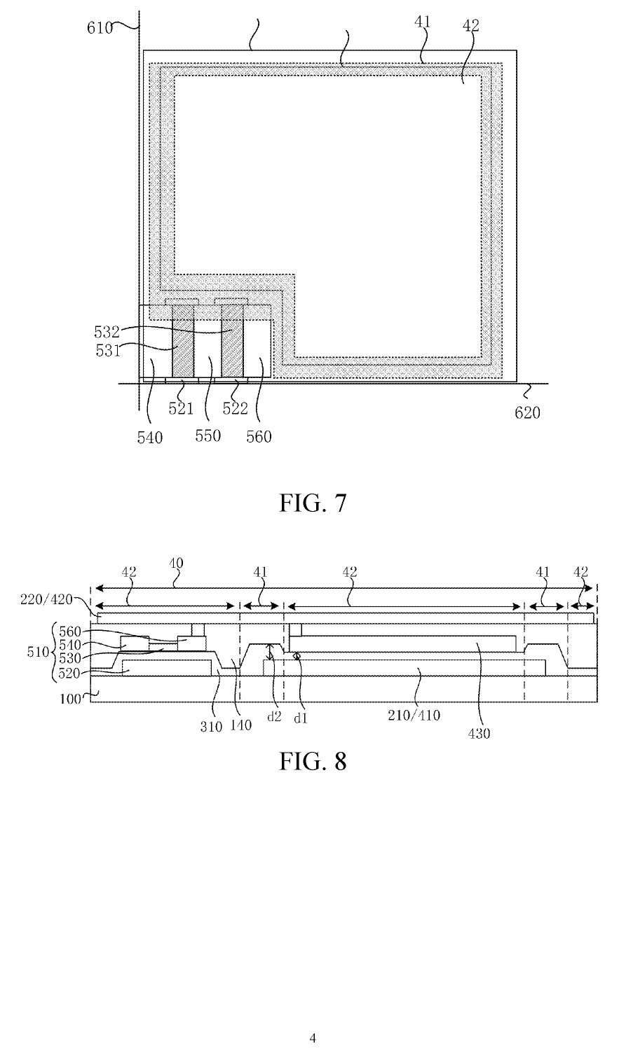

FIG. 7 is a schematic diagram of a dual-gate active switch according to a first embodiment of the present disclosure. As shown in FIG. 7, the array substrate 30 further includes a plurality of active switches 510. Each of the plurality of active switches 510 includes a gate 520, a semiconductor layer 530, a source 540, a connection electrode 550, and a drain 560. The gate 520 includes a first sub-gate 521 and a second sub-gate 522. The semiconductor layer 530 includes a first sub-semiconductor layer 531 and a second sub-semiconductor layer 532. The first sub-gate 521 and the second sub-gate 522 are disposed in the same layer as the first metal electrode 210. The source 540, the connection electrode 550, and the drain 560 are disposed in the same layer as the second electrode 220. The first sub-semiconductor layer 531 is located between the first insulating protective layer 310, the source 540 and the connection electrode 550. The second sub-semiconductor layer 532 is located between the first insulating protective layer 310, the connection electrode 550 and the drain 560.

The region where the active switch 510 is located within each of the plurality of pixel unit regions is defined as a plurality of switching regions 43. Each of the plurality of switching regions 43 includes an overlapping region 44 and a non-overlapping region 45, and a region where the switching region 43 partially overlaps with the thickened region 41 is defined as the overlapping region 44. A distance between the semiconductor layer 530 and the gate 520 in the overlapping region 44 is greater than a distance between the semiconductor layer 530 and the gate 520 in the non-overlapping region 45.

An on-state current of the plurality of active switches 510 in the overlapping region 44 is the same as an on-state current of the plurality of active switches 510 in the non-overlapping region 45.

Specifically, for the flexible electronic paper display panel 10 employing a dual-gate structure, the plurality of active switches 510 occupy a larger area. Therefore, without reducing the area of the first metal electrode 210, the overlapping area 44 of the flexible electronic paper display panel 10 with the dual-gate structure is also larger, correspondingly having a greater impact on the charging capability of the plurality of active switches 510.

Therefore, by making the electron mobility of the semiconductor layer 530 located in the overlapping region 44 of the plurality of active switches 510 greater than the electron mobility of the semiconductor layer 530 located in the non-overlapping region 45 of the plurality of active switches 510, it is possible to avoid reducing the area of the first metal electrode 210, thus preventing a decrease in the storage capacitance within each of the plurality of pixel unit regions 40; and also to avoid increasing the voltage of the plurality of scan lines 620, thus preventing an increase in the load on the flexible electronic paper display panel 10.

FIG. 8 is a schematic diagram of an array substrate according to a second embodiment of the present disclosure. As shown in FIG. 8, different from the first embodiment, this embodiment is provided with an auxiliary pixel electrode 430. Specifically, the array substrate 30 also includes an auxiliary pixel electrode 430. The auxiliary pixel electrode 430 is disposed between the first insulating protective layer 310 and the passivation insulating layer 140, that is, the auxiliary pixel electrode 430 is located in the second metal layer 130, and the auxiliary pixel electrode 430 is connected to the second electrode 420.

In some embodiments, the auxiliary pixel electrode 430 is directly connected to the second electrode 420 through a via. Alternatively, the auxiliary pixel electrode 430 may also be connected to the drains 560 of the plurality of active switches 510. Since the second electrode 420 is also connected to the drains 560 of the plurality of active switches 510, the auxiliary pixel electrode 430 is connected to the second electrode 420 through the drains 560 of the plurality of active switches 510.

Compared to the first embodiment, this embodiment adds an auxiliary pixel electrode 430 within the second metal layer 130. By increasing the storage capacitance between the auxiliary pixel electrode 430 and the first metal electrode 210, the storage capacitance within the plurality of pixel unit regions 40 is increased.

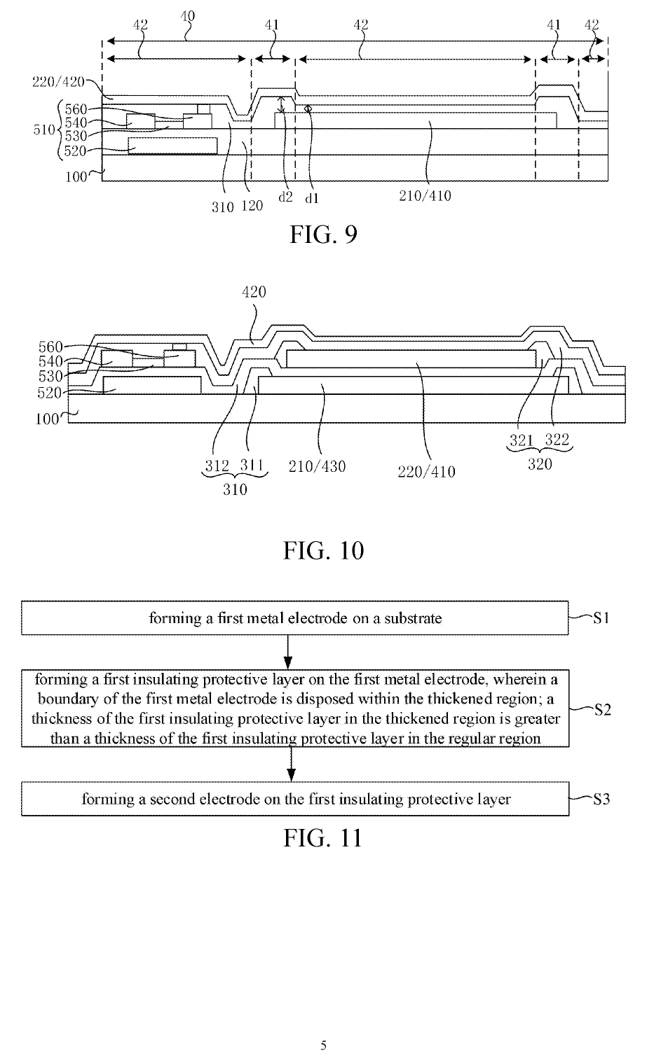

FIG. 9 is a schematic diagram of an array substrate according to a third embodiment of the present disclosure. As shown in FIG. 9, different from the first embodiment, the first metal electrode 210 in this embodiment is located within the second metal layer 130. Specifically, the first metal electrode 210 is a common electrode line 410, the second electrode 220 is a pixel electrode 420, and the array substrate 30 further includes a gate insulating layer 120. The gate insulating layer 120, the common electrode line 410, the first insulating protective layer 310, and the pixel electrode 420 are sequentially disposed on the substrate 100.

Compared to the first embodiment, this embodiment reduces the distance between the first metal electrode 210 and the second electrode 220 by placing the first metal electrode 210 inside the second metal layer 130, thereby improving the storage capacity of the storage capacitance in the plurality of pixel unit regions 40.

Furthermore, based on the above design, the first insulating protective layer 310 is located above the first metal electrode 210, and correspondingly above the semiconductor layer 530, source 540, and drain 560 of the plurality of active switches 510. This avoids raising the semiconductor layer 530, source 540, and drain 560 of the plurality of active switches 510, and eliminates the need to reduce the area of the first metal electrode 210, thus preventing a decrease in storage capacitance. Moreover, no modifications to the plurality of active switches 510 are required, thereby saving on manufacturing processes and reducing fabrication difficulty.

FIG. 10 is a schematic diagram of an array substrate according to a fourth embodiment of the present disclosure. As shown in FIG. 10, different from the first embodiment, the first metal electrode 210 is the auxiliary pixel electrode 430, the second electrode 220 is the common electrode line 410, and the array substrate 30 further includes a second insulating protective layer 320 and a pixel electrode 420. The auxiliary pixel electrode 430, the first insulating protective layer 310, the common electrode line 410, the second insulating protective layer 320 and the pixel electrode 420 are sequentially disposed on the substrate 100.

The second insulating protective layer 320 includes a second elastic layer 321 and a second insulating layer 322. The second elastic layer 321 is located between the second electrode 220 and the second insulating layer 322, and the second elastic layer 321 is only located in the thickened region 41. That is, the second elastic layer 321 covers the boundary of the second electrode 220. In this embodiment, the second elastic layer 321 covers the boundary of the common electrode line 410.

Compared to the third embodiment, in this embodiment, a storage capacitor is formed between the first metal electrode 210 and the second electrode 220, and a capacitor is formed between the second electrode 220 and the pixel electrode 420, thereby improving the storage capacity of the storage capacitor within the plurality of pixel unit regions 40.

The second elastic layer 321 covers the boundary of the first metal electrode 210 layer. In this embodiment, the second elastic layer 321 covers the boundary of the auxiliary pixel electrode 430. It is understood that the thickness of the second insulating protective layer 320 is uniform, the thickness of the second elastic layer 321 is 8000 μm to 10000 μm, and the thickness of the second insulating layer 322 is 3500 μm to 4000 μm.

The second elastic layer 321 is made of polystyrene (hereinafter referred to as PS) spacer material. The PS spacer material is elastic. Therefore, when the flexible electronic paper display panel 10 is bent, the second electrode 220 shifts, squeezing the PS spacer material at the edge. The PS spacer material deforms under pressure. Then, when the flexible electronic paper display panel 10 returns to flatness, the PS spacer material recovers its deformation and acts back on the second electrode 220. On the one hand, this prevents the second electrode 220 from shifting and failing to return to its original position under repeated bending of the flexible electronic paper display panel 10, which would reduce the overlap area between the first metal electrode 210 and the second electrode 220, resulting in relatively less capacity of the storage capacitance in the plurality of pixel unit regions 40. On the other hand, because the PS spacer material is elastic, it may absorb the shift of the second electrode 220, thereby preventing damage to the second insulating protective layer 320.

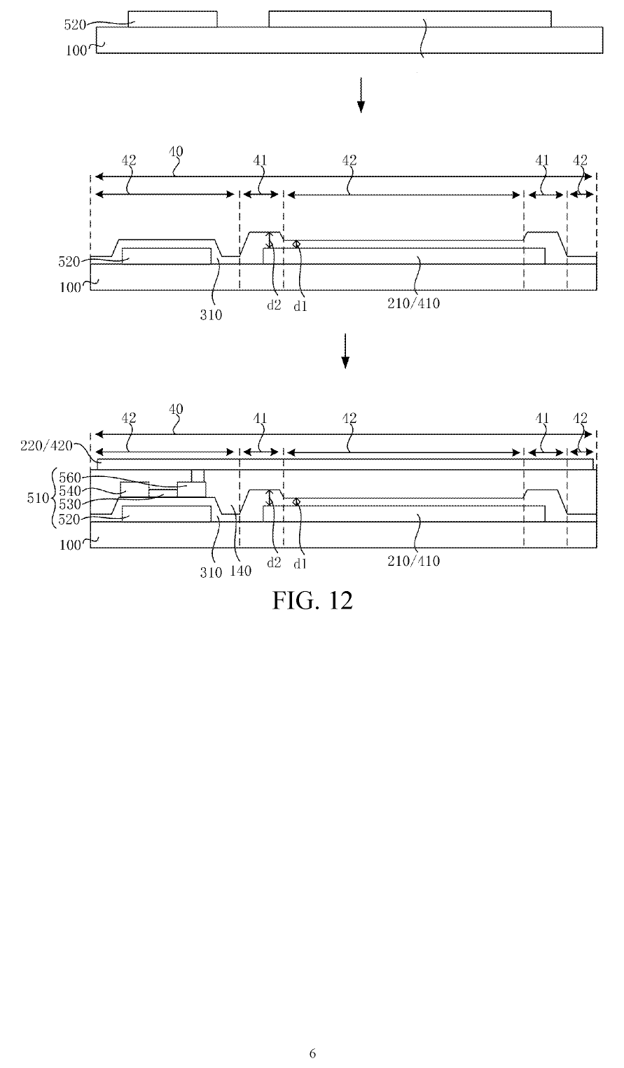

FIG. 11 is a flowchart of steps of a method for manufacturing an array substrate according to an embodiment of the present disclosure. FIG. 12 is a schematic diagram illustrating a method for manufacturing an array substrate according to an embodiment of the present disclosure. As shown in FIGS. 11 and 12, the present disclosure discloses a method for manufacturing an array substrate 30, the array substrate 30 including a plurality of pixel unit regions 40, each of the plurality of pixel unit regions 40 being divided into a thickened region 41 and a regular region 42; the method for manufacturing an array substrate includes the following steps: S1: forming a first metal electrode on a substrate; S2: forming a first insulating protective layer on the first metal electrode, wherein a boundary of the first metal electrode is disposed within the thickened region; and a thickness of the first insulating protective layer in the thickened region is greater than a thickness of the first insulating protective layer in the regular region; S3: forming a second electrode on the first insulating protective layer.

Compared to the array substrate 30 of exemplary technologies, the present disclosure provides the first insulating protective layer 310, with the thickness of the first insulating protective layer 310 in the thickened region 41 being greater than the thickness of the first insulating protective layer 310 in the regular region 42. Specifically, the first insulating protective layer 310 is thickened at a position covering a boundary of the first metal electrode 210. This prevents the edges of the first metal electrode 210 from bending and scratching the first insulating protective layer 310 when the flexible electronic paper display panel 10 is repeatedly bent, and also prevents the storage capacitance in the plurality of pixel unit regions 40 from decreasing, thus solving the problem of grayscale degradation in certain areas of the flexible electronic paper display panel 10. Furthermore, this design also prevents moisture intrusion, avoiding corrosion of the first metal electrode 210 and display abnormalities.

The step in S2 includes: S211: forming a first insulating protective layer of a first thickness on a first metal electrode; S212: irradiating the thickened region and the regular region respectively with a halftone process, wherein a tone level of the thickened region is 0%-10% and a tone level of the regular region is 40%-60%; and S213: etching to form a first insulating protective layer with a thickness of the thickened region greater than the thickness of the regular region.

The first insulating protective layer 310 located in the thickened region 41 is thickened by a halftone process, eliminating the need for two layers to add an extra process.

In some embodiments, the thickness of the first insulating protective layer 310 in the thickened region 41 may also be increased by adding a first elastic layer 311. Specifically, the step in S2 includes: S221: forming a first elastic layer on the first metal electrode; and S222: forming a first insulating layer on the first elastic layer, wherein the first elastic layer is located only in the thickened region.

The first elastic layer 311 is made of polystyrene (hereinafter referred to as PS) spacer material. The PS spacer material is elastic. Therefore, when the flexible electronic paper display panel 10 is bent, the first metal electrode 210 shifts, squeezing the PS spacer material at the edge. The PS spacer material deforms under pressure. Then, when the flexible electronic paper display panel 10 returns to flatness, the PS spacer material recovers its deformation and acts back on the first metal electrode 210. On the one hand, this prevents the first metal electrode 210 from shifting and failing to return to its original position under repeated bending of the flexible electronic paper display panel 10, which would reduce the overlap area between the first metal electrode 210 and the second electrode 220, resulting in relatively less capacity of the storage capacitance in the plurality of pixel unit regions 40. On the other hand, because the PS spacer material is elastic, it may absorb the shift of the first metal electrode 210, thereby preventing damage to the first insulating protective layer 310.

It should be noted that the limitation of each step involved in the present solution is not determined to limit the sequence of steps without affecting the implementation of the specific solution, and the step written in the foregoing may be prior. Execution may alternatively be carried out later, or even concurrently. As long as the scheme may be implemented, it should be considered as belonging to the scope of protection of this application.

It should be noted that the inventive concept of the present disclosure may be formed into many embodiments, but limitations of the application document preclude exhaustive listing. Therefore, should no conflict be present, the various embodiments or technical features described above may be arbitrarily combined to form new embodiments. After the various embodiments or technical features are combined, the original technical effects may be enhanced.

The foregoing content describes the present disclosure in further detail in conjunction with specific optional embodiments, but it should not be construed that the specific implementation of the present disclosure is limited solely to these descriptions. For those of ordinary skill in the art to which the present disclosure pertains, several simple deductions or replacements may be made without departing from the inventive concept of the present disclosure, and these should all be regarded as falling within the protection scope of the present disclosure.

What is claimed is:

1. An array substrate, applied to a flexible electronic paper display panel, comprising a plurality of pixel unit regions, each of the plurality of pixel unit regions being divided into a thickened region and a regular region;
wherein the array substrate further comprises a substrate, a first metal electrode, a first insulating protective layer and a second electrode, the first metal electrode, the first insulating protective layer and the second electrode are sequentially disposed on the substrate;
an orthographic projection of the first metal electrode on the substrate overlaps that of the second electrode on the substrate within each of the plurality of pixel unit regions;
a boundary of the first metal electrode is disposed within the thickened region; and a thickness of the first insulating protective layer in the thickened region is greater than a thickness of the first insulating protective layer in the regular region.

2. The array substrate according to claim 1, wherein the first insulating protective layer comprises a first elastic layer and a first insulating layer, the first elastic layer is located between the first metal electrode and the first insulating layer, and the first elastic layer is located only in the thickened region, so that the thickness of the first insulating protective layer in the thickened region is greater than the thickness of the first insulating protective layer in the regular region.

3. The array substrate according to claim 1, wherein the first metal electrode is a common electrode line, the second electrode is a pixel electrode, the array substrate further comprises a passivation insulating layer, and the common electrode line, the first insulating protective layer, the passivation insulating layer and the pixel electrode are sequentially disposed on the substrate.

4. The array substrate according to claim 1, wherein the first metal electrode is a common electrode line, the second electrode is a pixel electrode, the array substrate further comprises a gate insulating layer; and the gate insulating layer, the common electrode line, the first insulating protective layer and the pixel electrode are sequentially disposed on the substrate.

5. The array substrate according to claim 1, wherein the first metal electrode is an auxiliary pixel electrode, the second electrode is a common electrode line, the array substrate further comprises a second insulating protective layer and a pixel electrode; the auxiliary pixel electrode, the first insulating protective layer, the common electrode line, the second insulating protective layer and the pixel electrode are sequentially disposed on the substrate;
the second insulating protective layer comprises a second elastic layer and a second insulating layer; the second elastic layer is located between the second electrode and the second insulating layer, and the second elastic layer is located only in the thickened region.

6. The array substrate according to claim 2, wherein a thickness of the first elastic layer is in a range of 8000 μm to 10000 μm, and a thickness of the first insulating layer is 3500 μm to 4000 μm.

7. The array substrate according to claim 2, wherein the array substrate further comprises a plurality of active switches, each of the plurality of active switches comprising a gate, a semiconductor layer, a source, and a drain; the gate is disposed in a same layer as the first metal electrode;
the source and the drain are disposed in a same layer as the second electrode, and the semiconductor layer is located between the first insulating protective layer,the source and the drain;
a region where the active switch is located within each of the plurality of pixel unit regions is defined as a plurality of switching regions;
each of the plurality of switching regions comprises an overlapping region and a non-overlapping region, and a region where the switching region partially overlaps with the thickened region is defined as the overlapping region;
a distance between the semiconductor layer and the gate in the overlapping region is greater than a distance between the semiconductor layer and the gate in the non-overlapping region;
an on-state current of the plurality of active switches in the overlapping region is the same as an on-state current of the plurality of active switches in the non-overlapping region.

8. The array substrate according to claim 7, wherein a channel length of the plurality of active switches in the overlapping region of the semiconductor layer is less than a channel length of the plurality of active switches in the non-overlapping region of the semiconductor layer.

9. The array substrate according to claim 1, wherein the first metal electrode is comprises metal, and the second electrode comprises metal or metal oxide.

10. The array substrate according to claim 1, wherein the second electrode is a pixel electrode, the array substrate further comprises a plurality of data lines, a plurality of scan lines and a plurality of active switches, the plurality of data lines, the plurality of scan lines and the plurality of active switches are respectively disposed on the substrate; and
the gate of each of the plurality of active switches is connected to one of the plurality of scan lines, the source of each of the plurality of active switches is connected to one of the plurality of data lines, and the plurality of pixel electrodes are respectively connected to the drains of the plurality of active switches.

11. The array substrate according to claim 1, wherein the thickened region extends 8 μm to 10 μm inwardly from the boundary of the first metal electrode; and the thickened region extends 8 μm to 10 μm outwardly from the boundary of the first metal electrode.

12. The array substrate according to claim 1, wherein the thickened region completely covers a boundary of the first metal electrode entirely; or the thickened region only covers a portion of the boundary of the first metal electrode.

13. The array substrate according to claim 2, wherein the first elastic layer is made of polystyrene.

14. A method for manufacturing an array substrate, the array substrate comprising a plurality of pixel unit regions, each of the plurality of pixel unit regions being divided into a thickened region and a regular region; the method for manufacturing an array substrate comprises:
forming a first metal electrode on a substrate;
forming a first insulating protective layer on the first metal electrode, wherein a boundary of the first metal electrode is disposed within the thickened region; and a thickness of the first insulating protective layer in the thickened region is greater than a thickness of the first insulating protective layer in the regular region; and
forming a second electrode on the first insulating protective layer.

15. The method for manufacturing an array substrate according to claim 14, wherein the step of forming a first insulating protective layer on a first metal electrode, the thickened region covers a boundary of the first metal electrode; a thickness of the first insulating protective layer in the thickened region is greater than a thickness of the first insulating protective layer in the regular region, comprises:
forming a first elastic layer on the first metal electrode; and
forming a first insulating layer on the first elastic layer, wherein the first elastic layer is located only in the thickened region.

16. The method for manufacturing an array substrate according to claim 15, wherein the step of forming a first insulating protective layer on a first metal electrode, the thickened region covers a boundary of the first metal electrode; a thickness of the first insulating protective layer in the thickened region is greater than a thickness of the first insulating protective layer in the regular region, comprises:
forming a first insulating protective layer of a first thickness on a first metal electrode;
irradiating the thickened region and the regular region respectively with a halftone process, wherein a tone level of the thickened region is 0%-10% and a tone level of the regular region is 40%-60%; and
etching to form a first insulating protective layer with a thickness of the thickened region greater than that of the regular region.

17. A flexible electronic paper display panel, comprising an electrophoretic reflective layer and an array substrate, the array substrate being configured to drive the electrophoretic reflective layer to reflect light for displaying an image;
wherein the array substrate comprises a plurality of pixel unit regions, each of the plurality of pixel unit regions being divided into a thickened region and a regular region;
the array substrate further comprises a substrate, a first metal electrode, a first insulating protective layer and a second electrode, the first metal electrode, the first insulating protective layer and the second electrode are sequentially disposed on the substrate;
the first metal electrode overlaps the second electrode in the orthographic projection on the substrate within each of the plurality of pixel unit regions;
a boundary of the first metal electrode is disposed within the thickened region; and a thickness of the first insulating protective layer in the thickened region is greater than a thickness of the first insulating protective layer in the regular region.

18. The flexible electronic paper display panel according to claim 17, wherein the second electrode is a pixel electrode;
the flexible electronic paper display panel further comprises a common electrode layer, and an electric field is formed between the common electrode layer and the pixel electrodes of the array substrate.

19. The flexible electronic paper display panel according to claim 17, wherein the first insulating protective layer comprises a first elastic layer and a first insulating layer, the first elastic layer is located between the first metal electrode and the first insulating layer, and the first elastic layer is located only in the thickened region, so that the thickness of the first insulating protective layer in the thickened region is greater than the thickness of the first insulating protective layer in the regular region.

20. The flexible electronic paper display panel according to claim 17, wherein the first metal electrode is a common electrode line, the second electrode is a pixel electrode, the array substrate further comprises a passivation insulating layer, and the common electrode line, the first insulating protective layer, the passivation insulating layer and the pixel electrode are sequentially disposed on the substrate.
